(19) United States
(12) Patent Application Publication
(10) Pub. No.: US 2023/0256399 A1
(43) Pub. Date: Aug. 17, 2023

(54) FRACTAL MIXER REACTOR

(71) Applicant: AMALGAMATED RESEARCH LLC, Twin Falls, ID (US)

(72) Inventors: Mac Scott Brandon, Twin Falls, ID (US); John E. Buhrle, Twin Falls, ID (US); Ryan C. Capell, Twin Falls, ID (US); Michael M. Kearney, Twin Falls, ID (US)

(73) Assignee: AMALGAMATED RESEARCH LLC, Twin Falls, ID (US)

(21) Appl. No.: 18/109,582

(22) Filed: Feb. 14, 2023

Related U.S. Application Data
(60) Provisional application No. 63/310,248, filed on Feb. 15, 2022.

(51) Int. Cl. B01F 25/41; B01J 19/00; B01F 35/71

(52) U.S. Cl. CPC B01F 25/41; B01J 19/0093; B01F 35/7182; F28F 2210/02

(57) ABSTRACT

Systems and methods for mixing at least two mixing components, including a first mixing component independent fractal for transporting the first mixing component, a second mixing component independent fractal for transporting the second mixing component, wherein each of the first mixing component independent fractal and the second mixing component independent fractal comprise at least a first iteration of a fractal shape and a last iteration of the fractal shape, a contact channel in fluid communication with each of the last iterations for the first mixing component independent fractal and the second mixing component independent fractal, and a passive mixing structure located in at least a portion of the contact channel.

### CROSS-REFERENCE TO RELATED APPLICATIONS

This application, under 35 U.S.C. § 119, claims the benefit of U.S. Provisional Patent Application Ser. No. 63/310,248 filed on Feb. 15, 2022, and entitled “Fractal Mixing Reactor” the contents of which are hereby incorporated by reference herein. This application is also related to U.S. Pat. No. 6,742,924, issued Jun. 1, 2004, and titled “Fractal Device For Mixing And Reactor Applications,” the contents of which are hereby incorporated by reference herein.

### FIELD OF THE DISCLOSURE

This disclosure relates to mixing and reactor equipment and methods of use. In particular, the disclosure relates to systems and methods for mixing and/or reacting one or more fluids.

### BACKGROUND

Many fluid processes benefit from efficient mixing. Nearly all conventional art mixing equipment, such as blenders, impellers, static mixers, and impinging devices, scale and intermingle the fluids to be mixed while the fluids are in actual contact with one another. This approach can result in the creation of a variety of inhomogeneities within the body of the fluid mixture. Such inhomogeneities may be harmful to the process of mixing and/or the reactions occurring within the body of the fluid. For example, large scale concentration or temperature inhomogeneities may be produced within the body of the fluid mixture by the use of conventional mixing equipment.

Additionally, conventional mixing equipment generally relies upon forcing large scale turbulence upon the fluid mixture. Turbulence, in turn, may lead to the formation of eddies within the fluid body which, in many instances, may be as large as the reaction vessel itself. The presence of eddies within the fluid body may hamper the proper mixing of the fluid and further may disrupt the extent of the reactions occurring within the fluid.

Fractal reactors and mixers, such as those disclosed in U.S. Pat. No. 6,742,924, exist. However, some circumstances require alteration to existing structures. Some of those circumstances include, but are not limited to, the following: when the smallest desired fractal scale can plug due to suspended solids, when the smallest desired fractal scale can lead to manufacturing problems, when the smallest desired fractal scale is too expensive to manufacture, and when the smallest desired fractal scale involves laminar flow.

Other drawbacks, inefficiencies, and issues also exist with current systems and methods.

### SUMMARY

Accordingly, disclosed systems and methods address the above, and other, drawbacks, inefficiencies, and issues of existing systems and methods.

Disclosed embodiments include, but are not limited to, fractal mixers/reactors where independent flows of mixing components are progressively scaled through smaller and smaller conduit. At the smallest fractal scale, specifically where the mixing components come into contact with one another, a passive mixing structure completes the mixing process.

Disclosed embodiments show improved mixing and maintain the beneficial characteristics of fractal mixers and reactors even for the special cases listed above.

Disclosed embodiments include systems for mixing at least two mixing components, the systems having a first mixing component independent fractal for transporting the first mixing component, a second mixing component independent fractal for transporting the second mixing component, wherein each of the first mixing component independent fractal and the second mixing component independent fractal comprise at least a first iteration of a fractal shape and a last iteration of the fractal shape, a contact channel in fluid communication with each of the last iterations for the first mixing component independent fractal and the second mixing component independent fractal, and a passive mixing structure located in at least a portion of the contact channel.

In some embodiments the first mixing component independent fractal is located in a first plane and the second mixing component independent fractal is located in a second plane.

In some embodiments the passive mixing structure further comprises a static mixing structure. In other embodiments the passive mixing structure further comprises a turbulent mixing structure. In still further embodiments the passive mixing structure further comprises a laminar mixing structure.

In some embodiments the last iteration of the fractal shape is the smallest scale fractal. In some embodiments each of the last iterations for the first mixing component independent fractal and the second mixing component independent fractal meet in the contact channel at an angle ranging from 0° to 180°.

In some embodiments, the number of mixing components may be more than two mixing components, and the mixing may be simultaneous mixing or sequential mixing of one component after another.

Also disclosed are methods for mixing at least two mixing components, the methods including transporting a first mixing component in a first mixing component independent fractal; for transporting the first mixing component, transporting a second mixing component in a second mixing component independent fractal, wherein each of the first mixing component independent fractal and the second mixing component independent fractal comprise at least a first iteration of a fractal shape and a last iteration of the fractal shape, contacting the first mixing component and second mixing component in a contact channel in fluid communication with each of the last iterations for the first mixing component independent fractal and the second mixing component independent fractal, and mixing the first mixing component and the second mixing component in a passive mixing structure located in at least a portion of the contact channel.

Other advantages, efficiencies, and features of disclosed embodiments also exist.

### BRIEF DESCRIPTION OF THE DRAWINGS

FIG. 1 is an example of prior art fractal mixers.

FIG. 2 shows an exemplary location (dashed box) for a passive mixing structure to be introduced into the fractal mixer of FIG. 1 in accordance with disclosed embodiments.

FIGS. 3A-3F are a schematic illustration of a general method to progressively increase the contact surface area between mixing components in accordance with disclosed embodiments.

FIG. 4 is a top-down view of a surface type mixer/reactor in accordance with disclosed embodiments.

FIG. 5 is a top-down view of a surface exit fractal mixer/reactor in accordance with disclosed embodiments.

FIG. 6 is an isometric view of a surface exit mixer in accordance with disclosed embodiments.

FIG. 7 is a close-up, semi-transparent view of a portion of the surface exit mixer 600 of FIG. 6 in accordance with disclosed embodiments.

FIG. 8 is a side elevation, semi-transparent view of the surface exit mixer 600 of FIG. 6 in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

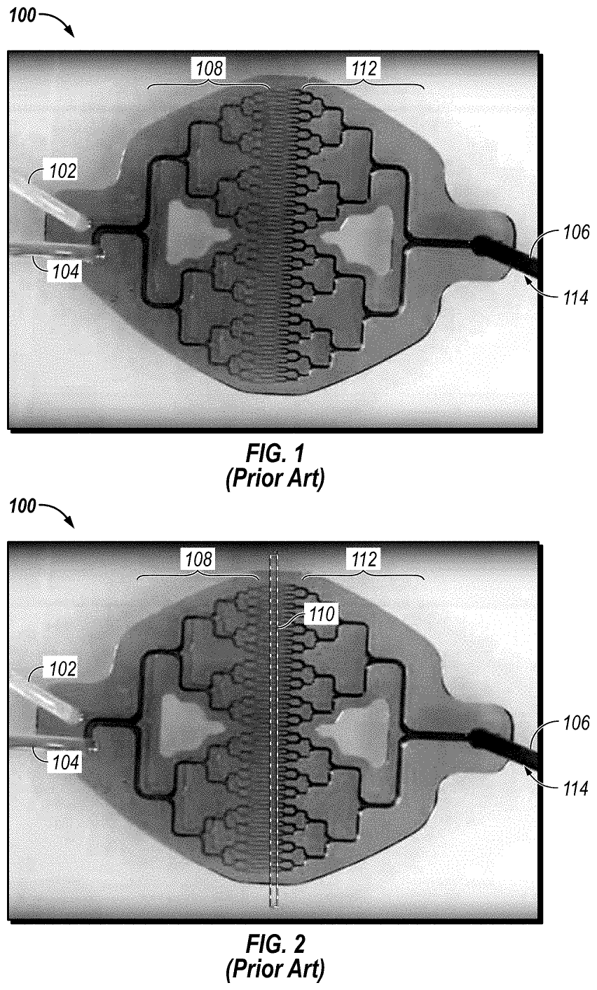

Disclosed embodiments include modifications of earlier fractal mixer embodiments made by Amalgamated Research LLC (ARi) of Twin Falls, Id., USA. For example, FIG. 1 is an illustration of an embodiment of an ARi fractal mixer 100. In FIG. 1, two fluids 102, 104 are mixed and optionally reacted as indicated at mixed fluid 106. The illustrated device 100 is used as an example and is shown as transparent, which is helpful for discussion, but need not be in other applications. The first fluid 102 and second fluid 104 are progressively and independently scaled smaller and smaller as indicated in scaling region 108 before making contact (in contact region 110 shown by dashed box in FIG. 2). At contact, and following mixing, the combined material is mixed as indicated at 106. Note that for this particular fractal mixer 100 embodiment, the product 106 is collected through an ever-expanding fractal region 112 and exits through the large exit tube 114 on the right. The “collection fractal” in the expanding region 112 is not generally necessary for the presently disclosed mixing discussion. One point of the present disclosure is that fluids 102, 104, are scaled in region 108 before they contact in region 110. Contact occurs in a homogenous manner at the smallest fractal scale.

It is important to recognize that when using conventional mixer types, for example, impeller driven tank mixers or static mixers, scale-up difficulties will always be encountered. With scale-up of these devices, Reynolds number will be altered, and certain dimensional ratios must change. As a result, predicting scale-up performance can become very complicated for conventional mixing techniques.

However, fractal mixers, such as mixer 100, and the fractal mixers with the designs disclosed herein do not encounter these typical mixing scale-up issues. As long as mixing/reactor results are understood at the smallest scale of fluid contact, the devices can be scaled to any size and maintain the same result. This means that thorough testing can be done with as little as one smallest scale contact channel and then, via fractal structure, predictably scaled to any desired flow rate.

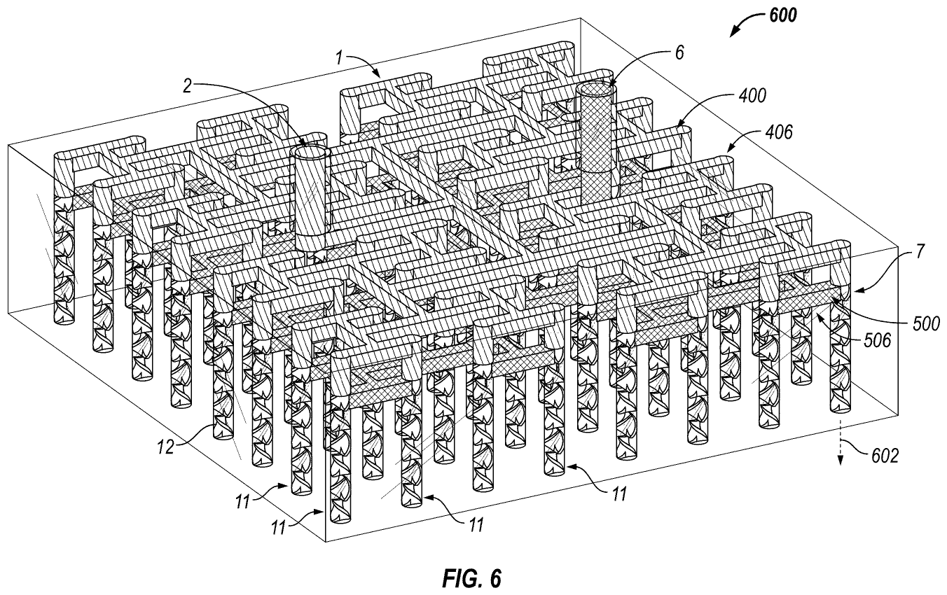

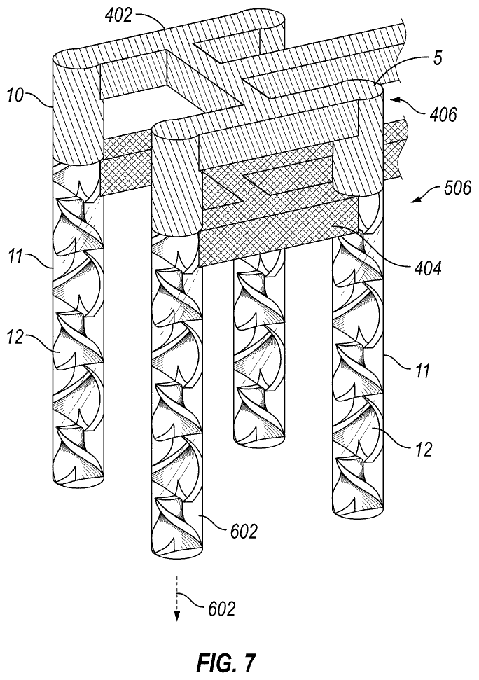

Presently disclosed embodiments involve adding passive mixing structures (e.g., mixing structures 12 as shown in FIGS. 6-7) at the smallest scale where the independent fractals merge and mixture components contact one another. One location for the passive mixing structures is indicated on FIG. 2 at the dashed box 110.

Passive Mixing Structure

As used herein, “passive mixing structure” means structure(s) which provide(s) a turbulent or laminar mixing within the smallest scale fractal contact/merging channels. Such structure can include conventional static mixer type elements or flow structure which results in stretch/fold or breakup/rejoin flow path geometry.

Static Mixer Elements as Passive Mixing Structure

Commercial (“off the shelf”) or in-house custom designed static mixer elements may be used as a component of disclosed passive mixing structure embodiments. The disclosed embodiments have application in both turbulent and laminar flows.

For fluids with Reynold's number less than 2000, mixing with static mixer elements is dependent upon flow division. For example, with the use of a particular type of laminar static mixer element, a first element splits the mixing components into two streams which are rotated 180 degrees. A second element splits the flow again, so now 4 streams (2, 4, 8, 16, etc., so an exponential increase in stratification). As the layers increase, the layer thickness decreases and the contact surface area (and therefore the extent of mixing) between components increases.

For fluids with a Reynold's number greater than 2000, the elements, as with laminar flow, mix due to flow division. However, elements also impart a rotational spin to the fluids which changes direction with each succeeding element. For turbulent flow, this radial mixing has a greater mixing effect than the flow division.

Stretch/Fold and Breakup/Rejoin as Passive Mixing Structure

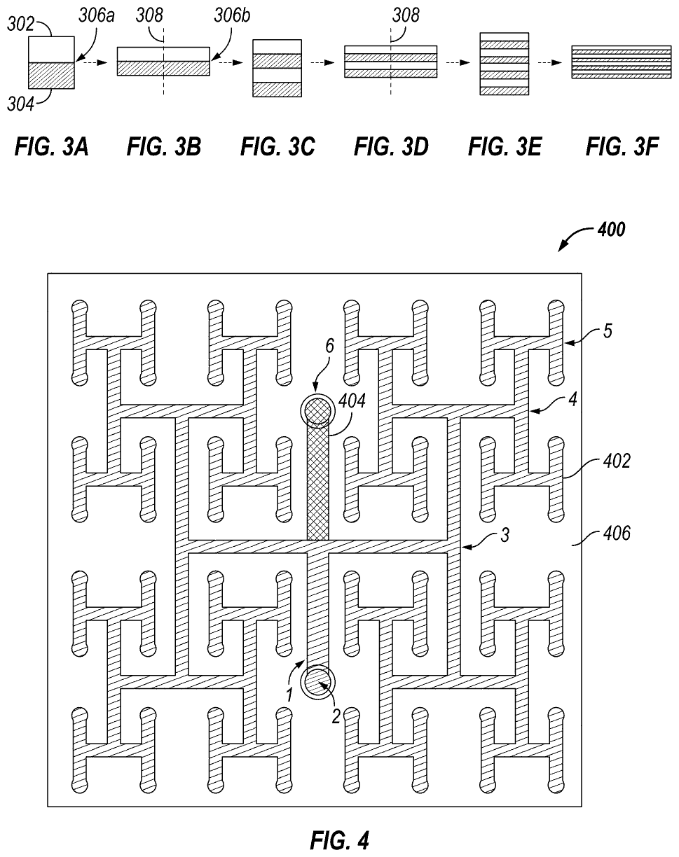

A variety of flow geometries can be used to mix via stretch/fold or breakup/rejoin. The general method is to progressively increase the contact surface area between mixing components and therefore eventually reach a mixed state. For example, the schematic concept shown in FIGS. 3A-3F can be implemented. As indicated schematically at FIG. 3A a first fluid 302 and a second fluid 304 may contact with a first surface area 306(a). As indicated at FIG. 3B the fluid contact surface area may be stretched to 306(b). As also indicated, the fluids 302, 304 may be broken up or divided at axis 308 and then folded or rejoined as indicated at FIG. 3C to approximately double the contact surface area of the original configuration in FIG. 3A. The disclosed stretch/fold or breakup/rejoin concept may be continued as many times as desired as indicated schematically in FIGS. 3D-3F.

Fractal Mixing Reacting

ARi is the inventor of engineered fractal mixing/reaction, for example, as shown in U.S. Pat. No. 6,742,924, and others. One method uses fractal conduit structure to scale mixture components and increase their individual contact surface area prior to contact of the separate mixture components. Conventional (i.e., non-fractal) mixing is typically accomplished through turbulence, which is uncontrollable, asymmetric, and energetically expensive. Unlike turbulent mixers, ARi fractal mixers and fractal reactors are designed to maximize symmetry and minimize the unpredictable characteristics of turbulence. Rather than using turbulent fluid collisions, fractal mixers use precise engineered channeling to achieve fluid scaling and mixing, reducing energy use and improving process efficiency. Furthermore, reactions can proceed while minimizing off-reactions.

As demonstrated by U.S. Pat. No. 6,742,924, in fractal mixers, components to be mixed or reacted typically do not contact one another until fluid scaling is complete, eliminating issues such as large-scale process inhomogeneities or side reactions. In addition, because the final fluid contact volume can be extremely small, it is possible to alter many mixing and reaction conditions (such as pH or temperature) in a near instantaneous manner.

Some applications for fractal mixers and reactors include, but are not limited to, the following:

Liquid-liquid mixers/reactors;

Gas-gas mixers/reactors;

Liquid-gas mixers/reactors;

Multi-phase reactors;

Aerators;

Carbonators; and

Combustion mixers/reactors.

Because fractals are, by definition, scaling structures, fractal mixers and fractal reactors can be evaluated at lab or pilot-scale and reliably scaled up to any desired industrial size.

Returning to FIG. 1, note that the first fluid 102 and second fluid 104 mixture components are scaled to a relatively small dimension and interspersed with one another (e.g., in region 108) prior to contact in region 110. Upon contact, the mixture components are already disbursed in a uniform manner, have been scaled to form a very large contact surface area, and can mix very quickly. This is in opposition to usual turbulent mixing where mixing components are in contact during the scaling (turbulent) process and mixing time is lengthened as the components must eventually be scaled and dispersed. The lengthened mixing time using turbulence can result in undesirable effects in addition to energy dissipation and inhomogeneity. For example, in the case of reactions, lengthened mixing time can result in undesirable off-reactions (examples of conventional turbulent mixing devices include static mixers and impellers). While the presently disclosed embodiments can involve the use of conventional static mixing elements, they are not used in their conventional inefficient manner as discussed herein.

ARi's fractal mixing has been demonstrated to be an efficient method of mixing. A number of fluid processing and other plants featuring this technology are installed throughout the world. These existing devices are typically large (3.9 to 6.55 meter diameter) and are indicative of the industrial scale to which the disclosed embodiments can be applied.

As discussed herein, while existing fractal mixers are successful mixing devices, there are special cases where the device may not reach maximum efficiency due to certain constraints on the smallest desired scale (the final smallest scale conduit). Therefore, the disclosed embodiments are options to be considered for special cases where the smallest scale fractal structure is, in some manner, problematic (as described above).

In order to address the special cases of small-scale fractal mixing difficulties, ARi has recognized that these issues may be significantly reduced by replacing the final smallest scale fractal structure with smallest scale passive mixing structure. Although this will introduce the negatives associated with such devices, their impact will be much reduced. Since material will already be scaled and homogenized within the fractal structure, the final small passive structure will result in relatively fast mixing time and efficiency. The larger scale turbulent energy dissipation and inhomogeneities will, for the most part, still be eliminated.

Advantages of the disclosed embodiments include, but are not limited to, the following:

very low energy consumption;

fast mixing time;

high efficiency for industrial scale turbulent flows;

high efficiency for flows which convert to laminar at the smallest fractal scale;

reduction of stagnation and back-mixing;

elimination of large scale inhomogeneities;

useful for reactions where sensitivity to mixing is high (high mixing Damkoehler number);

useful for avoiding side reactions with fast competitive-consecutive reactions;

useful for avoiding side reactions with fast competitive parallel reactions;

useful for enabling fast sequential reactions; and

useful for allowing immediate alteration of mixer/reactor conditions.

It is noted that a particular manufacturing technique or material is not required to realize the disclosed embodiments. Furthermore, for a given device, it is recognized that the manufacturing materials and methods may change depending upon the scale of different sections of the device. For example, it may be easiest or most cost effective to use computer aided machining to manufacture the largest scales of the device (largest conduit), while a different technique such as molding may be most efficient for manufacture of the smaller scales.

Any conventional techniques such as computer aided machining, photochemical etching, laser cutting, molding, and micro-machining may be used. Additive manufacturing techniques are also very applicable. Additive manufacturing techniques in general include binder jetting, directed energy deposition, powder bed fusion, sheet lamination, material extrusion, material jetting and vat photopolymerization. Additive manufacturing can be particularly applicable to the smallest scale passive mixing structure since these elements can have a quite complicated 3D structure and may be difficult to manufacture using more conventional methods. Other manufacturing techniques and materials may also be used.

The following exemplary embodiments are provided for illustration of a variety of ways to configure a fractal mixer 100. For example, FIG. 1 illustrates a mixer 100 design where the components to be mixed (i.e., fluids 102, 104) are passed through independent fractals that are in an expanding 2D cone type of layout (e.g., scaling region 108) with independent fractals parallel to one another. Other mixer 100 designs can incorporate independent fractals at variable angles from one another (i.e., other than parallel), including the extreme of fluids colliding in the contact channels (i.e., contact region 110) directed 180 degrees from one another (i.e., “head on” collision of flows).

The number of mixing components can be of any number, for simultaneous mixing or for rapid sequential mixing of one component after another.

In the following fractal mixer 400 embodiment (shown in FIG. 4), two components 402, 404 are mixed and exit across a surface 406. This type of configuration is useful where the mixed material is subsequently treated across a bed of another material. Example applications are chromatography, ion exchange, distillation, a reactive bed, or the like.

FIG. 4 is a top-down view of the surface-type mixer/reactor 400 and focuses on the independent first mixing component 402 fractal. As indicated in FIG. 4, 1 indicates the independent fractal for the first mixing component 402, the inlet 2 is the inlet for the first mixing component 402. The first iteration of the independent first component 402 fractal is shown at 3. The second iteration of the independent first component 402 fractal is shown at 4. The third iteration of the independent first component 402 fractal is shown at 5. The inlet of the second mixing component 404 is shown at 6.

It is noted that one of the valuable characteristics of the fractal mixing structure is that scale-up to higher flowrates is accomplished by adding larger and larger fractal iterations (i.e., fourth iteration, fifth iteration, etc.). And there is no limit on the number of iterations which can be used. In the FIG. 4 example, only three iterations are illustrated for simplicity.

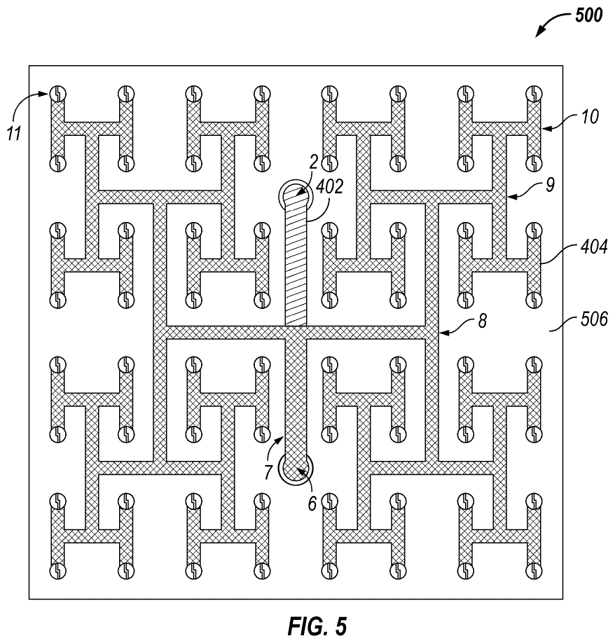

As illustrated in FIG. 4, the first component 402 flows from the inlet 2, through the smaller and smaller iterations of the fractal (i.e., fractal iterations 3, 4, 5) and to the smallest contact channel 11 (see FIG. 5) where it is mixed with the second mixing component 404 using a passive mixing structure (passive mixing structure not shown in this drawing).

FIG. 5 is a top-down view of a surface 506 exit fractal mixer 500 with focus on the independent second mixing component 404 fractal. As indicated in FIG. 5, the inlet 2 is for the first mixing component 402 and inlet 6 is for the second mixing component 404 as also shown in FIG. 4. As indicated the independent fractal 7 is for the second mixing component 404. The first iteration of the fractal is indicated at 8 for the independent second mixing component 404. The second iteration is indicated at 9 for the independent second mixing component 404 and the third iteration is indicated at 10 for the independent second mixing component 404. As indicated, each third iteration 10 terminates in a contact channel 11 for the first 402 and second 404 mixing components and contains a passive mixing structure (examples shown in FIGS. 6-8).

As with the first component 402, the second component 404 flows from the inlet 6, through the smaller and smaller iterations of the fractal (i.e., 8, 9, 10) and to the contact channel 11 where it is mixed with the first mixing component 402.

FIG. 6 is an isometric view of a surface exit mixer 600. As indicated in FIG. 6 inlet 2 is for the first mixing component 402 and inlet 6 is for the second mixing component 404. As shown first mixing surface 406 is “above” second mixing surface 506, but need not be so, and other configurations (e.g., side-by-side, etc.) are possible. As also shown, the third iterations (5, 10) of each independent mixing fractal (1, 7) flow into final contact channels 11 which contain a passive mixing structure 12. The contact channel 11 occurring in the third iteration of the fractal is merely exemplary and other iterations may also be used as disclosed herein.

As will be apparent to those of ordinary skill in the art having the benefit of this disclosure, in use the first 402 and second 404 fluids flow through independent fractals (1, 7) for eventual mixing. In the embodiment of FIG. 6 the first and second fractals (1, 7) are kept independent by placing the iterative structure for each on different planes (i.e., surfaces 406, 506). At the smallest desired scale (e.g., third iterations 5, 10), the first 402 and second 404 mixing components contact one another in the final contact channels 11 which contain passive mixing structures 12. The mixed product 602 exits the contact channels 11 and approximately covers a surface (not shown).

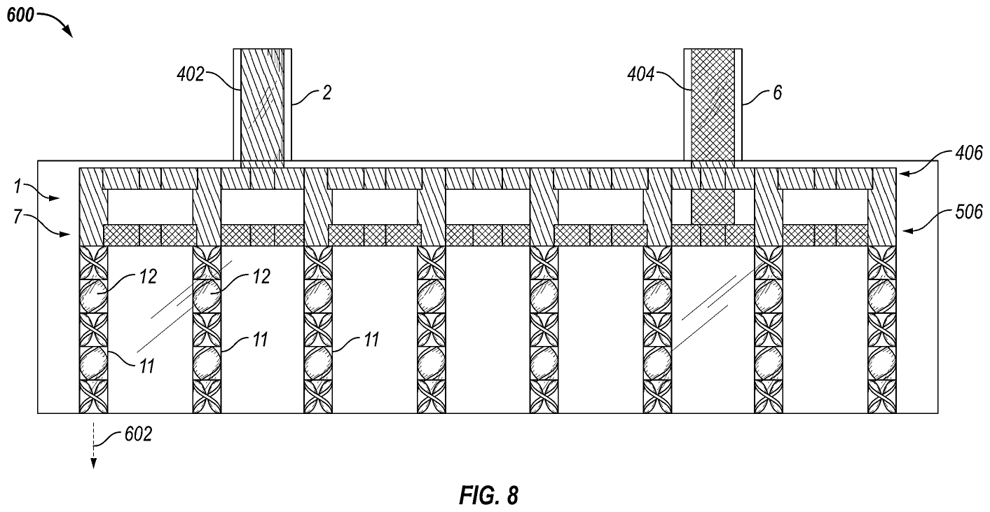

FIG. 7 is a close-up, semi-transparent view of a portion of the surface exit mixer 600 of FIG. 6 in accordance with disclosed embodiments. FIG. 8 is a side elevation, semi-transparent view of the surface exit mixer 600 of FIG. 6 in accordance with disclosed embodiments. Like numbers indicate like items throughout FIGS. 4-8.

Although various embodiments have been shown and described, the present disclosure is not so limited and will be understood to include all such modifications and variations would be apparent to one skilled in the art.

What is claimed is:

1. A system for mixing at least two mixing components, the system comprising:
a first mixing component independent fractal for transporting the first mixing component;
a second mixing component independent fractal for transporting the second mixing component;
wherein each of the first mixing component independent fractal and the second mixing component independent fractal comprise at least a first iteration of a fractal shape and a last iteration of the fractal shape;
a contact channel in fluid communication with each of the last iterations for the first mixing component independent fractal and the second mixing component independent fractal; and
a passive mixing structure located in at least a portion of the contact channel.

2. The system of claim 1 wherein the first mixing component independent fractal is located in a first plane and the second mixing component independent fractal is located in a second plane.

3. The system of claim 1 wherein the passive mixing structure further comprises a static mixing structure.

4. The system of claim 1 wherein the passive mixing structure further comprises a turbulent mixing structure.

5. The system of claim 1 wherein the passive mixing structure further comprises a laminar mixing structure.

6. The system of claim 1 wherein the last iteration of the fractal shape is the smallest scale fractal.

7. The system of claim 1 wherein each of the last iterations for the first mixing component independent fractal and the second mixing component independent fractal meet in the contact channel at an angle ranging from 0 (zero) to 180 (one hundred eighty) degrees.

8. The system of claim 1 wherein the number of mixing components comprises more than two mixing components, and the mixing may be simultaneous mixing or sequential mixing of one component after another.

9. A method for mixing at least two mixing components, the method comprising:
transporting a first mixing component in a first mixing component independent fractal; for transporting the first mixing component;
transporting a second mixing component in a second mixing component independent fractal;
wherein each of the first mixing component independent fractal and the second mixing component independent fractal comprise at least a first iteration of a fractal shape and a last iteration of the fractal shape;
contacting the first mixing component and second mixing component in a contact channel in fluid communication with each of the last iterations for the first mixing component independent fractal and the second mixing component independent fractal; and
mixing the first mixing component and the second mixing component in a passive mixing structure located in at least a portion of the contact channel.

10. The method of claim 9 wherein the first mixing component independent fractal is located in a first plane and the second mixing component independent fractal is located in a second plane.

11. The method of claim 9 wherein the passive mixing structure further comprises a static mixing structure.

12. The method of claim 9 wherein the passive mixing structure further comprises a turbulent mixing structure.

13. The method of claim 9 wherein the passive mixing structure further comprises a laminar mixing structure.

14. The method of claim 9 wherein the last iteration of the fractal shape is the smallest scale fractal.

15. The method of claim 9 wherein each of the last iterations for the first mixing component independent fractal and the second mixing component independent fractal meet in the contact channel at an angle ranging from 0 (zero) to 180 (one hundred eighty) degrees.

16. The method of claim 9 wherein the number of mixing components comprises more than two mixing components, and the mixing may be simultaneous mixing or sequential mixing of one component after another.
